(19) United States
(12) Patent Application Publication
(10) Pub. No.: US 2008/0216408 A1
(43) Pub. Date: Sep. 11, 2008

(54) Security gate

(76) Inventors: Jordan Letkeman, Steinbach (CA); Larry Buhler, Winnipeg (CA); James Buhler, Winnipeg (CA); Shannon Kehler, Winnipeg (CA)

Correspondence Address: ADE & COMPANY INC., 2157 Henderson Highway, WINNIPEG, MB, R2G1P9, CA

(21) Appl. No.: 11/506,198

(22) Filed: Aug. 18, 2006

Related U.S. Application Data
(60) Provisional application No. 60/789,134, filed on Apr. 5, 2006.

(51) Int. Cl. E05F 15/14; E05F 15/06

(52) U.S. Cl. 49/340; 49/339

(57) ABSTRACT

A security gate comprises a pair of posts fixed adjacent opposing sides of a gate opening. The gate includes a pair of first gate panels pivotally mounted on the posts and second gate panels pivotally coupled to the outer ends of the first gate panels respectively so that the second gate panels meet one another in the closed position of the gate. Each first gate panel and the respective second gate panel pivotally coupled thereto are moveable together between an open position folded adjacent the respective post and a closed position spanning across the gate opening. A drive linkage is coupled between each post and the inner end of the respective first gate panel pivotally coupled thereto to drive pivotal movement of the first gate panel between the open and closed position. A guide mechanism is coupled between the fixed post and the inner end of the second gate panel for guiding pivotal movement of the second gate panel between the open and closed positions responsive to movement of the first gate panel.

This application claims the benefit under 35 U.S.C. 119(e) of U.S. provisional application Ser. No. 60/789,134, filed Apr. 5, 2006.

### FIELD OF THE INVENTION

The present invention relates to a security gate for selectively spanning a gate opening and more particularly relates to a security gate comprising a pair of hinged gate panels driven by a linkage between open and closed positions.

### BACKGROUND

A common structure of a security gate includes an upright post fixedly supported on both sides of a gate opening across which the gate is to span. Each post mounts a gate member thereon comprising a pair of hinged panels which are foldable relative to the post between a closed position in which the free ends of the gate members meet at the center of the gate opening and the panels span the opening, and an open position in which the panels are folded so that the free ends of the gate members are positioned adjacent the posts respectively. Known security gate designs require a drive linkage to be coupled between the post and the free end of each gate member so that a suitable housing for the drive linkage must span between the posts, either in an overhead enclosure or an underground enclosure. In either instance considerable limitations prevent installation of the gate in a variety of applications due to the limited height requirements for the overhead enclosures or the complex and costly installation requirements for below ground drive linkages.

### SUMMARY OF THE INVENTION

According to one aspect of the invention there is provided a gate for selectively spanning a gate opening, the gate comprising:

a post arranged to be fixed mounted in an upright orientation adjacent one side of the gate opening;

a first gate panel spanning from an inner end to an outer end, the first gate panel being pivotally mounted on the post for relative pivotal movement about a first vertical axis at the inner end of the first gate panel;

a second gate panel spanning from an inner end to an outer end, the second gate panel being pivotally mounted on the outer end of the first gate panel so as to be arranged for relative pivotal movement about a second vertical axis at the inner end of the second gate panel;

the first and second gate panels being movable together between an open position in which the first and second gate panels are folded relative to one another and the outer end of the second gate panel is adjacent the post and a closed position in which the first and second gate panels each extend away from the post from the respective inner ends to the respective outer ends thereof to span the gate opening;

a drive linkage coupled between the post and the first gate panel, the drive linkage being arranged to drive pivotal movement of the first gate panel relative to the post between the open and closed positions;

a guide mechanism coupled to the second gate panel and being arranged to guide pivotal movement of the second gate panel relative to the first gate panel as the first gate panel is displaced between the open and closed positions.

By providing a drive linkage which can be coupled directly to the first panel adjacent the posts, a simpler and lower cost construction results which does not require an elaborate housing for coupling the drive linkage to the free ends of the second panels. Coupling of the drive linkage directly to the first panel adjacent the inner end thereof can be accomplished by use of the guide mechanism coupled to the second panel. When driving the first panel directly, the guide mechanism may take the form of a simple surface mounted track below the gate, or in other embodiments an auxiliary link coupled between the post and the second panel. By simplifying the form of the housing spanning between the two posts, the gate can be installed more simply and in more varied locations.

Preferably the drive linkage is coupled to the first gate panel adjacent the inner end thereof.

The drive linkage may comprise a rotary motor coupled to a crank arm and a connector link pivotally coupled between a free end of the crank arm and the first gate panel.

Spacing between the connector link and the first vertical axis is preferably greater than the length of the crank arm.

When the gate is pivoted forwardly towards the open position and the crank arm is pivotal about a respective vertical axis, the crank arm preferably extends rearwardly from the respective vertical axis in the closed position and generally forwardly from the respective vertical axis in the open position.

When the gate is pivoted forwardly towards the open position, the drive linkage preferably includes a motor supported adjacent a rear end of the post.

The drive linkage may be supported adjacent a top end of the post.

Preferably, the drive linkage is only coupled to the first gate panel while the guide mechanism is coupled only to the second gate panel.

In a preferred arrangement, there is provided a pair of posts supported at opposing sides of the gate opening, each post supporting a first gate panel and a second gate panel thereon such that the outer ends of the second gate panels meet centrally between the posts in the closed position.

In some embodiments, the guide mechanism may include a track spanning the gate opening and a follower coupled to the outer end of the second gate panel for following the track in which the track is supported either above or below the gate panels.

Preferably the track comprises a flat bottomed channel for flush mounting above a roadway across which the first and second gate panels span in the closed position.

There may be provided a partial track spanning only partway across the gate opening adjacent the outer end of the second panel in the closed position. The partial track preferably comprises a channel having a mouth of increased lateral dimension at the free end thereof.

In a preferred embodiment, the guide mechanism is coupled to the second gate panel adjacent the inner end of the second gate panel. The guide mechanism may only be coupled between the post and the second gate panel and is arranged to pivot the second gate panel relative to the first gate panel near 180 degrees when the first gate panel is pivoted relative to the post near 90 degrees between the closed and open positions.

The guide mechanism preferably comprises a rotary drive member in fixed relation to the post adjacent the inner end of the first gate panel, a rotary driven member in fixed relation to the second gate panel adjacent the inner end of the second gate panel, and a connecting member comprising a flexible member operatively coupled about the rotary drive member and the rotary driven member so as to be arranged to drive relative rotation of the rotary driven member responsive to relative rotation of the rotary drive member.

The rotary drive member is preferably concentric with the first vertical axis and the rotary driven member is preferably concentric with the second vertical axis.

Various embodiments of the invention will now be described in conjunction with the accompanying drawings in which:

### BRIEF DESCRIPTION OF THE DRAWINGS

FIG. 1 is a perspective view of a first embodiment of the gate.

FIG. 2 is a front elevation view of the gate accordingly to FIG. 1.

FIG. 3 is a top plan view and FIG. 4 is an end elevational view of the gate according to FIG. 1.

FIG. 5 and FIG. 6 are schematic top plan views of the drive linkage in respective closed and open positions of the gate according to FIG. 1.

FIG. 7 is a sectional view of a surface mounted track for use with the gate according to FIG. 1.

FIG. 8 and FIG. 9 are top plan schematic views of the drive linkage in respective closed and opened positions according to a second embodiment of the gate.

FIG. 10 and FIG. 11 are schematic top plan views of the drive linkage in respective closed and open positions of the gate according to a third embodiment of the gate.

FIG. 12 is a perspective view of a fourth embodiment of the gate.

FIG. 13 is an enlarged perspective view of an encircled portion of FIG. 12.

FIG. 14 and FIG. 15 are schematic top plan views of the drive linkage in respective closed and open positions of the gate according to FIG. 12.

In the drawings like characters of reference indicate corresponding parts in the different figures.

### DETAILED DESCRIPTION

Referring to the accompanying figures there is illustrated a security gate generally indicated by reference numeral 10. The security gate 10 is particularly suited for selectively spanning a gate opening across a roadway and the like. Although various embodiments of the gate are shown in the accompanying illustrations, the common features of each will first be described herein.

The security gate 10 includes a pair of posts 12 which are fixed mounted in the ground in an upright orientation at opposing sides of the gate opening spanning therebetween. A pair of gate members 14 are pivotally supported on the posts 12 respectively. Each gate member includes a first panel 16 and a second panel 18 comprised of a rigid rectangular frame including perimeter frame members and crossbars spanning there across.

The first panel spans between an inner end 20 pivotally supported on the post 12 for relative pivotal movement about a first vertical axis to an outer end 22. The second panel 18 spans from a first end 24 pivotally supported on the outer end 22 of the first panel to an outer end 26 which comprises a free end of the gate member 14. The first and second panels are pivotal relative to one another about a respective second vertical axis at the outer end of the first panel and at the inner end of the second panel.

Each gate member of the gate is accordingly pivotal between a closed position in which the panels fully span the gate opening between the posts so that the two gate members meet at the respective free ends thereof centrally between the posts and in which the gate panels are substantially coplanar, and an open position in which the gate panels are folded relative to one another so that the free ends at the outer ends of the second panels are positioned adjacent the posts. Typically in the closed position the panels are not actually fully coplanar with one another, but rather are pivoted only slightly from a coplanar position towards the open position. When closed, all of the gate panels span from their respective inner ends to the their respective outer ends in a direction away from the respective post towards the center of the gate opening.

Each post 12 comprises a hollow tubular housing of rectangular cross section which supports a drive linkage 28 thereon which is used to drive the gate panels between their respective open and closed position. As shown in the illustrated embodiment, the drive linkage 28 is supported at the top end of each post 12 for coupling directly between the post 12 and the respective first panel 16 adjacent the inner end 20 thereof. The drive linkage includes a motor 30 which is housed within the hollow interior of the post adjacent the rear end thereof. The motor 30 is electrically driven. The first panel 16 of each gate member is pivotally coupled on a front side 32 of the respective post 12 so that the panels are pivoted forwardly towards the open position opposite location of the motor 30 adjacent the rear end of the post.

The drive linkage 28 of each post includes a crank arm 34 which is coupled to the output of the motor 30 for pivotal movement about a vertical axis of the motor output between the closed position in which the crank arm 34 extends rearward at a very slight inward angle to the open position in which the crank arm 34 extends forwardly at an inward angle. The crank arm 34 is rotated through an arc between the open and closed positions at an inner side of the post in a direction from which the gate extends when closed.

The drive linkage further includes a connecting link 36 which is coupled pivotally between the free end of the crank arm 34 and the first gate panel 16 adjacent the inner end thereof. Accordingly the crank arm 34, the connecting link 36 and the first panel 16 together form a four bar linkage driven between open and closed positions by the motor 30. The connecting link 36 is pivotally coupled to the first panel adjacent the inner end at a spacing from the first vertical axis which is selected to be approximately twice in magnitude the length of the crank arm 34 between the pivotal axis thereof and its point of pivotal connection with the connecting link 36.

An additional guide mechanism 38 is coupled to the second panel 18 for guiding movement of the second panel relative to the first panel as the first panel is driven from the closed position to the open position and back again.

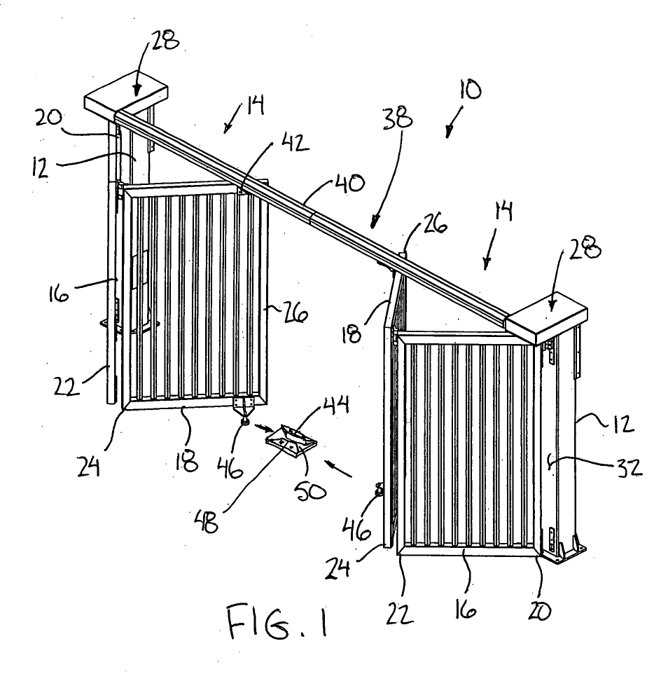

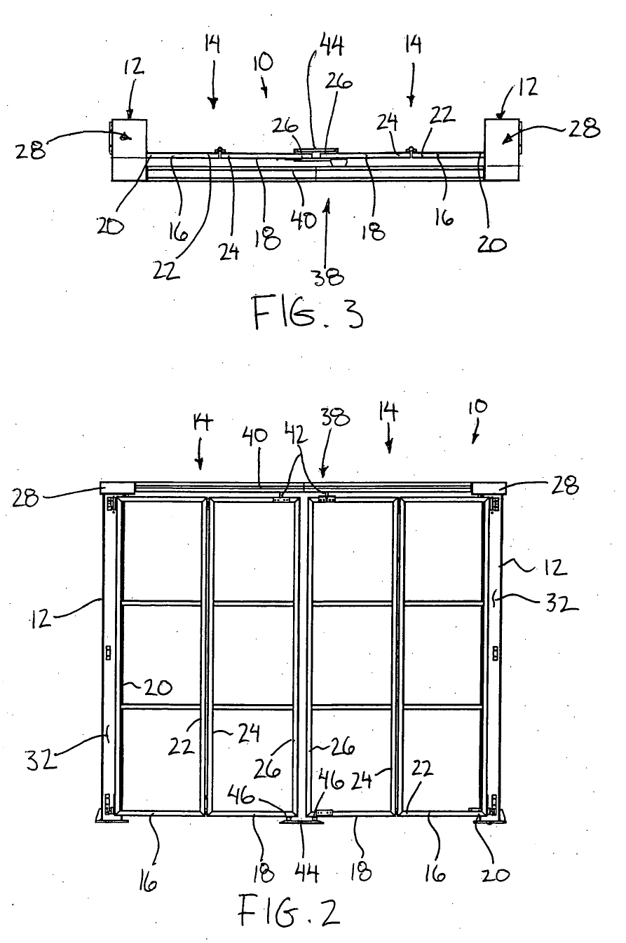

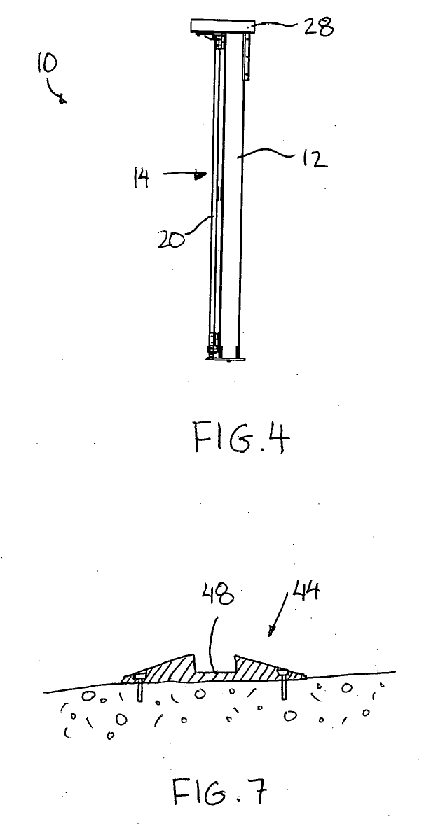

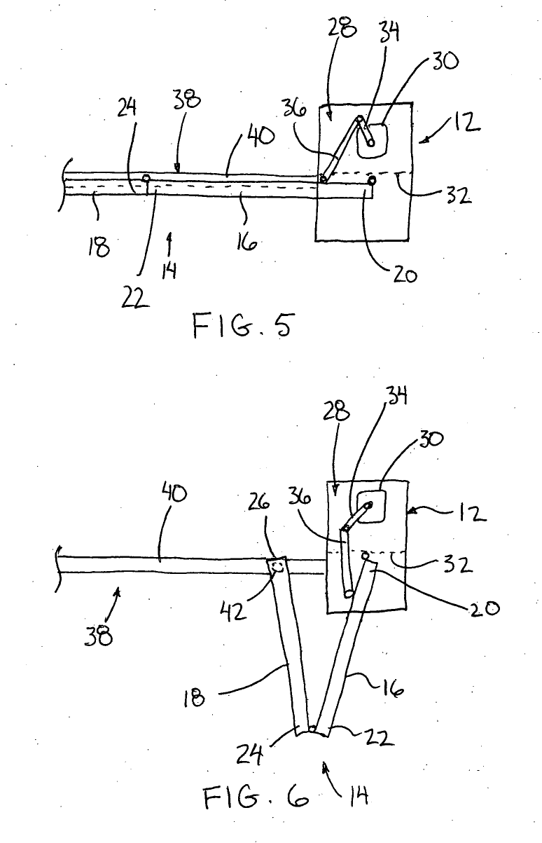

Turning now more particularly to the first embodiment of FIGS. 1 through 7, the drive linkage 28 is shown supported only at the top end of each post 12. In further embodiments a drive linkage 28 may be provided at a bottom end of the post or at both top and bottom ends of each post.

In the first embodiment the guide mechanism 38 comprises a top track 40 spanning between the top ends of the post 12 across the gate opening. A guide wheel 42 is mounted at the top end of each gate member 14 at the free outer end of the second panels 18 to guide movement of the free end of each gate member along the track between the posts and the center of the gate opening as the first panels are pivoted between the open and closed positions by the motor 30.

A bottom track 44 is provided for mounting on the ground centrally between the two posts 12. The bottom track 44 in the illustrated embodiment comprises only a partial track which receives respective guide wheels 46 at the free ends of the respective gate members 14 only as the gate members approach the closed position. The guide wheels 46 are mounted below the free end of each gate member 14 at the outer end of the second panels for being received selectively within an upwardly facing channel 48 formed in the bottom track 44. The channel 48 includes a mouth 50 of enlarged lateral dimension at each end thereof for easing insertion of the respective guide wheels 46 into the channel as the gate panels approach the closed position. The channel 48 is formed within a plate member having a flat bottom and bolt apertures formed therein for fastening at the surface of a concrete roadway and the like upon which the gate is installed.

In further variations, the bottom track 44 may comprise a full track spanning fully between the posts 12 in addition to or instead of the top track 40 illustrated.

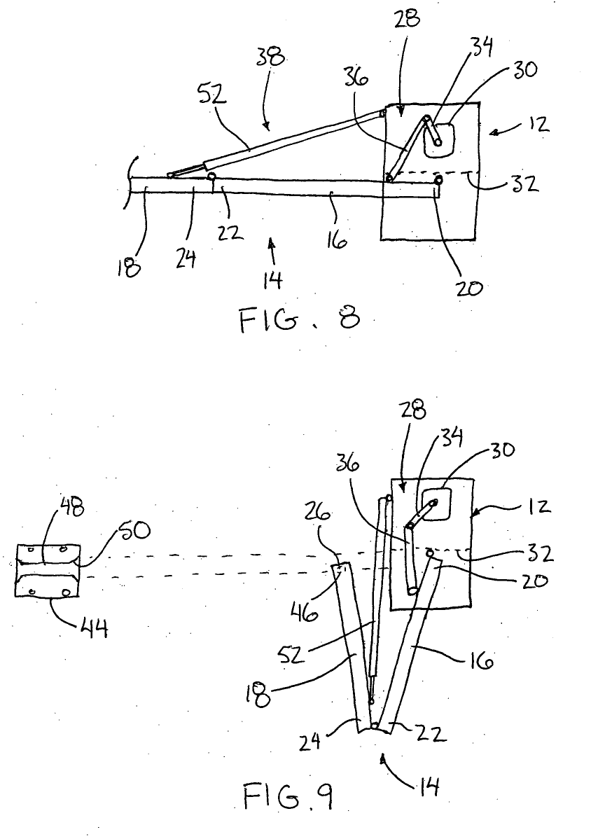

Turning now to the embodiment of FIGS. 8 and 9, no full track is required either above or below the door, but rather a partial bottom track 44 as described above provides reinforcement to the outer end of the second gate panel when closed. The guide mechanism 38 in this embodiment instead comprises an auxiliary connector link 52 which is pivotally coupled directly between the post and the second panel 18 of each gate member. Each connector link 52 is pivotally supported on the post towards the rear side thereof and spaced inwardly towards the opposing post in relation to the first vertical axis of the first panel coupled to the post. The connector link 52 is pivotally coupled on the second panel 18 adjacent the inner end 24 thereof. The distance between the pivotal connection of the auxiliary connector link 52 on the second panel and the second vertical axis is arranged to be approximately half in magnitude as compared to the spacing of the pivotal connection of the auxiliary connector link 52 on the post to the first vertical axis of the first panel pivoted on the post.

The connector link 52 comprises a telescoping gas cylinder of the type used as a shock absorber which is arranged to have a limited linear displacement in the order of approximately 1½ inches over a length of several feet. The telescoping auxiliary connector link 52 is used in cooperation with a partial bottom track 44 as described above with regard to the first embodiment so that the wide mouth 50 at the ends of channel 48 guides the free ends of the gate members to their final closed position.

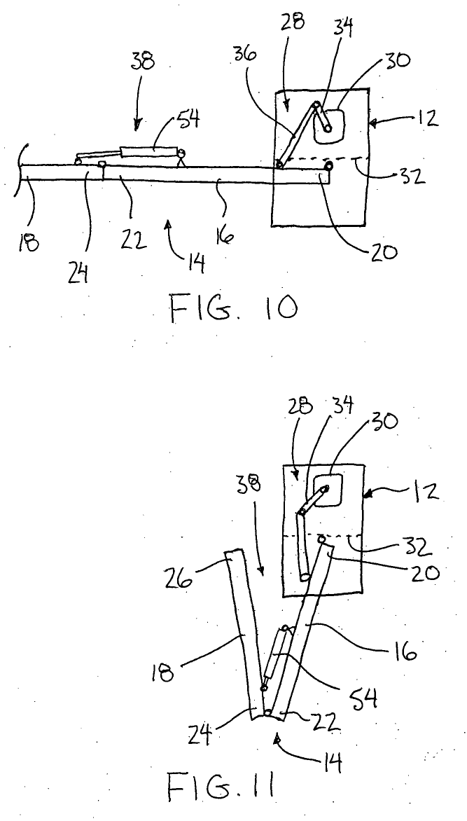

Turning now to the embodiment of FIGS. 10 and 11, no track at all is required, or only a partial track 44 may be used, when the guide mechanism comprises an auxiliary actuator 54 coupled between the first and second panels of each gate member to drive pivotal movement of the second panel relative to the first panel. Each auxiliary actuator 54 is mounted on the first panel at approximately mid-length therealong and is pivotally connected to the second panel near the inner end thereof so that linear displacement between the ends of the auxiliary actuator 54 causes pivotal movement of the second panel relative to the first panel. In this arrangement the motor 30 of the drive linkage and the auxiliary actuator 54 are commonly actuated for displacing the gate panels between the respective open and closed positions together.

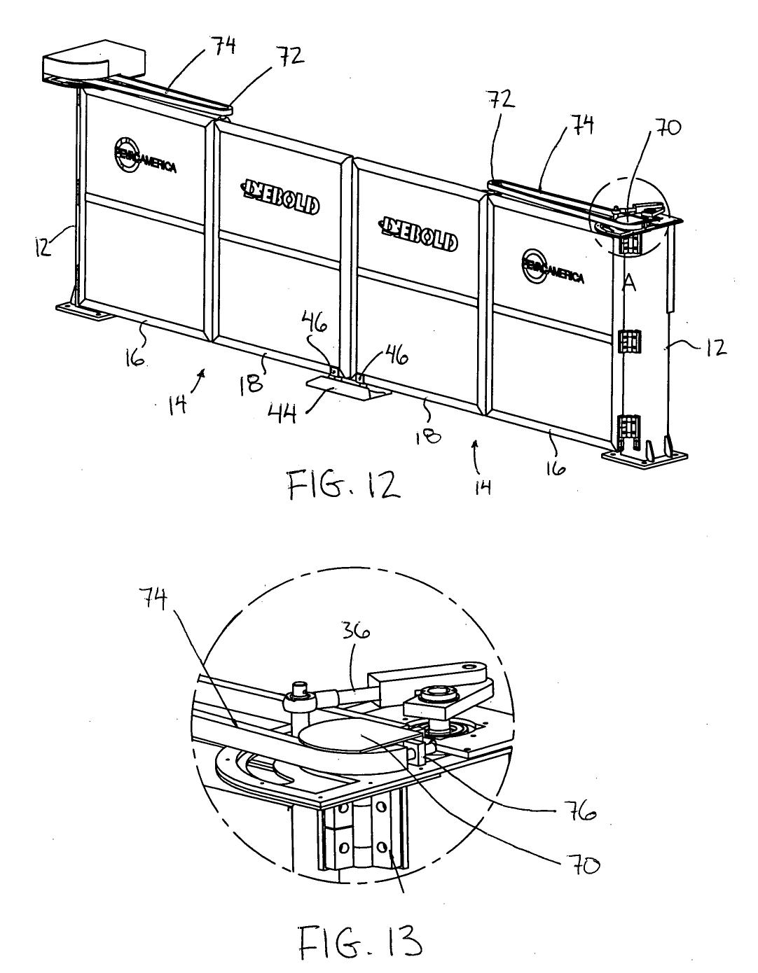

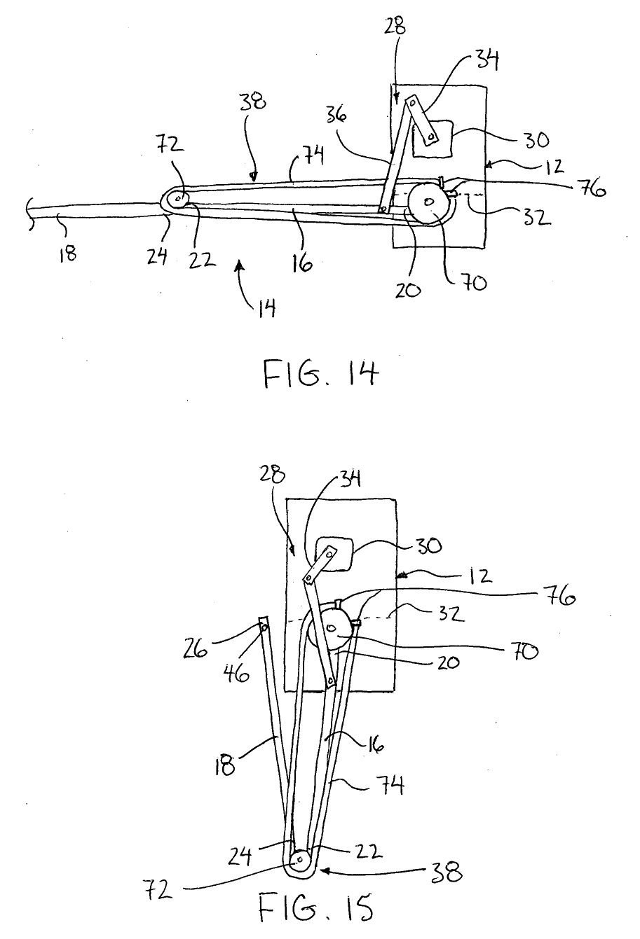

Turning now to FIGS. 12 through 15 a further embodiment of the gate is illustrated in which the guide mechanism 38 comprises a chain drive. In this instance the second gate panel is operated by the guide mechanism 38 to be rotated through near 180 degrees in relation to the first gate panel in response to the first gate panel being rotated through near 90 degrees relative to the fixed post. The guide mechanism 38 comprises only a mechanical linkage coupled between only the fixed post and the second gate panel so that no additional drive motors and the like are required to effect pivotal movement of the second gate panel relative to the first gate panel when the first gate panel is rotated between respective open and closed positions of the gate.

The accurate control provided by the guide mechanism 38 in this instance does not require a full track for guiding the outer free end of the second gate panel between the open and closed positions, but rather only a partial track 44 as described above with regard to previous embodiments is used. The partial track 44 in this instance acts primarily to reinforce the free outer end of the second gate panel in the closed position, however it is not required for guiding movement of the outer end of the second gate panel towards the closed position. In alternative embodiments the outer free end of the second gate panel may instead be latched to an opposing gate panel or to an opposing fixed post for reinforcement instead of using the partial track 44.

As shown in the embodiment of FIGS. 12 through 15, the guide mechanism 38 comprises a rotary drive member 70, comprising a gear, and a rotary driven member 72, also comprising a gear, in which the drive member 70 and driven member 72 are operatively connected by a connecting member 74. The rotary drive member is supported concentrically about the first vertical axis of the first gate panel at the inner end of the first gate panel, adjacent the top end of the post. The rotary drive member 70 is fixed in relation to the post so that the first gate panel pivots relative to the gear comprising the rotary gear drive member 70 when it is pivoted between open and closed positions relative to the post.

The rotary driven member 72 also comprises a gear, but it is mounted concentrically about the second vertical axis which defines the pivotal movement between the second gate panel relative to the first gate panel. The rotary driven member 72 is fixed to the second gate panel to pivot with the second gate panel relative to the first gate panel.

The connecting member 74 comprises an elongate flexible drive chain extending about both the rotary drive member 70 and the rotary driven member 72 so as to be operatively connected between the two gears. The connecting member 74 thus effectively rotates the rotary driven member 72 about the respective second vertical axis in response to the rotary drive member 70 being rotated about the first vertical axis relative to the first gate panel as the first gate panel is pivoted between open and closed positions.

The drive ratio or gear ratio between the rotary drive member 70 and the rotary driven member 72 is arranged to be approximately 2:1 so that the rotary driven member effects twice as much rotation relative to the first gate panel as the first gate panel rotates relative to the rotary drive member 70. In use, the rotary driven member 72 is only rotated through 180 degrees relative to the first gate panel when the first gate panel is rotated through 90 degrees relative to the rotary drive member 70.

Chain tighteners 76 anchor opposing ends of the connecting member 74 at the rear side of the rotary drive member 70 so as to also be fixed in relation to the post at the rear side of the rotary drive member. The chain tighteners 76 ensure that the connecting member 74 is drawn tight between the rotary drive member 70 and the rotary driven member 72 to maintain an operative connection between the drive member and the driven member through relative rotation of the gate panels when opening and closing the gate.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A gate for selectively spanning a gate opening, the gate comprising:
a post arranged to be fixed mounted in an upright orientation adjacent one side of the gate opening;
a first gate panel spanning from an inner end to an outer end, the first gate panel being pivotally mounted on the post for relative pivotal movement about a first vertical axis at the inner end of the first gate panel;
a second gate panel spanning from an inner end to an outer end, the second gate panel being pivotally mounted on the outer end of the first gate panel so as to be arranged for relative pivotal movement about a second vertical axis at the inner end of the second gate panel;
the first and second gate panels being movable together between an open position in which the first and second gate panels are folded relative to one another and the outer end of the second gate panel is adjacent the post and a closed position in which the first and second gate panels each extend away from the post from the respective inner ends to the respective outer ends thereof to span the gate opening;
a drive linkage coupled between the post and the first gate panel, the drive linkage being arranged to drive pivotal movement of the first gate panel relative to the post between the open and closed positions;
a guide mechanism coupled to the second gate panel and being arranged to guide pivotal movement of the second gate panel relative to the first gate panel as the first gate panel is displaced between the open and closed positions.

2. The gate according to claim 1 wherein the drive linkage is coupled to the first gate panel adjacent the inner end thereof.

3. The gate according to claim 1 wherein the drive linkage comprises a rotary motor coupled to a crank arm and a connector link pivotally coupled between a free end of the crank arm and the first gate panel.

4. The gate according to claim 3 wherein spacing between the connector link and the first vertical axis is greater than the length of the crank arm.

5. The gate according to claim 3 wherein the gate is pivoted forwardly towards the open position and the crank arm is pivotal about a respective vertical axis, the crank arm extending rearwardly from the respective vertical axis in the closed position.

6. The gate according to claim 3 wherein the gate is pivoted forwardly towards the open position and the crank arm is pivotal about a respective vertical axis, the crank arm extending generally forwardly from the respective vertical axis in the open position.

7. The gate according to claim 1 wherein the gate is pivoted forwardly towards the open position, the drive linkage including a motor supported adjacent a rear end of the post.

8. The gate according to claim 1 wherein the drive linkage is supported adjacent a top end of the post.

9. The gate according to claim 1 wherein the drive linkage is only coupled to the first gate panel.

10. The gate according to claim 1 wherein there is provided a pair of posts supported at opposing sides of the gate opening, each post supporting a first gate panel and a second gate panel thereon such that the outer ends of the second gate panels meet centrally between the posts in the closed position.

11. The gate according to claim 1 wherein the guide mechanism comprises a track spanning the gate opening and a follower coupled to the outer end of the second gate panel for following the track.

12. The gate according to claim 11 wherein the track is supported above the gate panels.

13. The gate according to claim 11 wherein the track is supported below the gate panels.

14. The gate according to claim 13 wherein the track comprises a flat bottomed channel for flush mounting above a roadway across which the first and second gate panels span in the closed position.

15. The gate according to claim 13 wherein there is provided a partial track spanning only partway across the gate opening adjacent the outer end of the second panel in the closed position.

16. The gate according to claim 15 wherein the partial track comprises a channel having a mouth of increased lateral dimension at the free end thereof.

17. The gate according to claim 1 wherein the guide mechanism is coupled to the second gate panel adjacent the inner end of the second gate panel.

18. The gate according to claim 1 wherein the guide mechanism is only coupled between the post and the second gate panel and is arranged to pivot the second gate panel relative to the first gate panel near 180 degrees when the first gate panel is pivoted relative to the post near 90 degrees between the closed and open positions.

19. The gate according to claim 1 wherein the guide mechanism comprises a rotary drive member in fixed relation to the post adjacent the inner end of the first gate panel, a rotary driven member in fixed relation to the second gate panel adjacent the inner end of the second gate panel, and a connecting member comprising a flexible member operatively coupled about the rotary drive member and the rotary driven member so as to be arranged to drive relative rotation of the rotary driven member responsive to relative rotation of the rotary drive member.

20. The gate according to claim 19 wherein the rotary drive member is substantially concentric with the first vertical axis and the rotary driven member is substantially concentric with the second vertical axis.
